(19) United States
(12) Patent Application Publication
(10) Pub. No.: US 2008/0116175 A1
(43) Pub. Date: May 22, 2008

(54) LASER WELDING PROCESS WITH IMPROVED PENETRATION

(75) Inventors: Gaia Ballerini, Saint Maur des Fosses (FR); Francis BRIAND, Paris (FR); Philippe Lefebvre, Meulan (FR)

Correspondence Address: YOUNG & THOMPSON, 209 Madison Street, Suite 500, ALEXANDRIA, VA, 22314, US

(73) Assignee: L'AIR LIQUIDE SOCIETE ANONYME POUR L'ETUDE ET L'EXPLOITATION DES PROCEDES GEORGES CLAUDE, PARIS (FR)

(21) Appl. No.: 11/942,135

(22) Filed: Nov. 19, 2007

(30) Foreign Application Priority Data
Nov. 17, 2006 (FR) 06 54966

(51) Int. Cl. B23K 26/12; B23K 26/20

(52) U.S. Cl. 219/74; 219/121.64

(57) ABSTRACT

The invention relates to a welding process using a laser beam (FL1, FL2) to weld at least one metal workpiece, preferably to weld two metal workpieces together, in which: a first laser beam (FL1) is employed and said first laser beam (FL1) is focused so that it strikes at least one workpiece to be welded and creates a keyhole-type capillary (KH) having a keyhole opening; a second laser beam (FL2) is used and said second laser beam (FL2) is focused in the keyhole (KH) opening created by said first laser beam (FL1); and the workpiece or workpieces are progressively welded by melting the metal of the workpiece or workpieces to be welded at the points of impact of the laser beams (FL1, FL2) with the workpiece or workpieces to be welded. The depth of penetration (x) of the first laser beam (FL1) is greater than the depth of penetration (y) of the second laser beam (FL2).

The invention relates to a laser welding process with increased welding penetration.

In deep-penetration laser welding, that is to say typically with a penetration of up to 15 or 20 mm approximately, the laser beam is focused by a dedicated device onto the work zone, for example by a lens, a mirror, an optical fibre or combinations thereof.

The energy density in the impact zone must be sufficient to ensure at least the formation and maintenance of a vapour capillary or keyhole.

This is because welding with a laser beam relies on the material melting and vaporizing at the point of impact of the beam.

For specific power densities that are high enough, that is to say at least a few MW/cm², a capillary or keyhole filled with metal vapour forms in the material and allows direct transfer of the energy to the core of the material.

The walls of the capillary are formed from molten metal and maintained thanks to a dynamic equilibrium being established with the internal vapour and thereby forming a kind of opening or central cavity in the core of the weld pool. Depending on the movement, the molten metal circumvents the capillary, to form behind the latter a “weld pool” formed from molten metal.

The size of this opening or cavity in the keyhole depends on the laser spot focused onto the surface of the material.

Several methods or devices are used to improve the properties of the weld and to reduce weld defects. Mention may for example be made of remote laser welding, beam shaping (to form a spot of oblong shape, a double spot or multiple spots, etc.), the application of a dynamic gas pressure to the opening in the keyhole, the use of special gas delivery nozzles, or else the use of an additional energy source, such as a TIG, MIG/MAG arc or plasma to obtain laser/arc hybrid welding.

These various devices or methods make it possible to modify the geometry of the keyhole opening and to stabilize it somewhat.

This conventionally results in an increase in the size of the keyhole, which becomes greater than that of the laser beam that strikes the surface of the workpiece to be welded.

Thus, in the case in which the beam shape is controlled (oblong spot, double spot, etc.), the size of the keyhole opening is determined by the cross section of the particular shape of the laser beam, whereas in remote laser welding with an oscillating beam or with the use of an assistance gas or an additional power source, the width of the keyhole cavity that results therefrom is larger than that of the beam.

Similar observations have been made in high-speed welding in which the width of the keyhole is determined by the angle of inclination of the front of the keyhole and by the reflection of the beam off this front.

All these methods increase the dimensions of the keyhole and of the weld pool, but do not allow the laser welding penetration depth to be increased—they even sometimes result in this welding depth being reduced.

Moreover, document U.S. Pat. No. 6,608,278 describes a laser welding process in which two laser beams are used, these being focused in succession, one after the other, in the plane of the joint to be welded so as to obtain a single keyhole. This process helps to improve the welding quality by limiting the incorporation of coating materials into the weld when welding coated parts, especially zinc-coated parts. Document JP-A-60240395 teaches a laser welding process similar to that described by U.S. Pat. No. 6,608,278.

Document EP-A-1 491 279 describes a laser welding process in which a laser beam is divided into several sub-beams that are focused coaxially and/or in a plane perpendicular to the weld joint so as to obtain a high joint quality.

Document DE-A-19 902 909 relates to a laser welding process in which a laser beam is divided into several sub-beams that are focused at several focal points lying in the joint plane and/or on either side of said joint plane.

Furthermore, mention may also be made of documents DE-A-10 113 471 and EP-A-1 350 590 relating to laser-arc hybrid welding.

Accordingly, one problem that arises is how to improve existing laser welding processes so as to deepen the welding penetration.

One solution to this problem is therefore a welding process using a laser beam to weld at least one metal workpiece, preferably to weld two metal workpieces together, in which:

a) a first laser beam is employed and said first laser beam is focused so that it strikes at least one workpiece to be welded and creates a keyhole-type capillary having a keyhole opening;

b) a second laser beam is used and said second laser beam is focused in the keyhole opening created by said first laser beam; and

c) the workpiece or workpieces are progressively welded by melting the metal of the workpiece or workpieces to be welded at the points of impact of the laser beams with the workpiece or workpieces to be welded,

and in which the depth of penetration (x) of the first laser beam and the depth of penetration (y) of the second laser beam are such that: y>x where x is the depth of the keyhole created by the first laser beam.

Depending on the case, the process of the invention may comprise one or more of the following features:

the first laser beam is separate from the second laser beam;

the focal length (f2) of the second laser beam and the focal length (f1) of the first laser beam are such that f2>f1, preferably such that: f2=f1+x where x is the keyhole depth obtained with the first laser beam;

the laser beams are obtained from a main beam, which is divided into said two beams or from two separate laser beams of the same wavelength or of different wavelengths;

a first gas stream is used to create a dynamic, preferably continuous and constant, gas pressure on the opening of the vapour capillary created by the first laser beam in order to keep it open and in that a second, shielding gas stream is furthermore employed, this being distributed peripherally with respect to the first gas stream;

the flow rate of the first gas is around 5 to 30 l/min, preferably around 10 to 20 l/min, and the flow rate of the second gas is around 15 to 40 l/min, preferably around 20 to 30 l/min;

the nozzle delivering the first gas stream is directed towards the keyhole—it may be approximately coaxial with the keyhole or else placed in front of or behind said keyhole;

the first and second gases are chosen from argon, helium, nitrogen and mixtures thereof, and possibly in smaller proportion CO₂, oxygen or hydrogen;

the laser beam is generated by a laser generator of the Nd:YAG, diode, ytterbium-doped fibre or CO₂ laser type;

the metal workpiece or workpieces to be welded are made of carbon steel, whether coated or not, aluminium or stainless steel;

the distance w separating the first laser beam from the second laser beam is such that: a<w<b where a is the width of the keyhole opening and b is the width of the keyhole bottom;

the straight line passes through the centres of the first laser beam and the second laser beam is parallel to the welding direction or makes an angle of between 1 and 60° to said welding direction, preferably an angle of between 1° and 45°;

an electric arc is generated in the keyhole so as to enlarge and stabilize the keyhole; and

the nozzle delivering the first gas has a gas flow area smaller than the nozzle delivering the second gas.

The invention will be more clearly understood thanks to the following description given with reference to the appended figures in which:

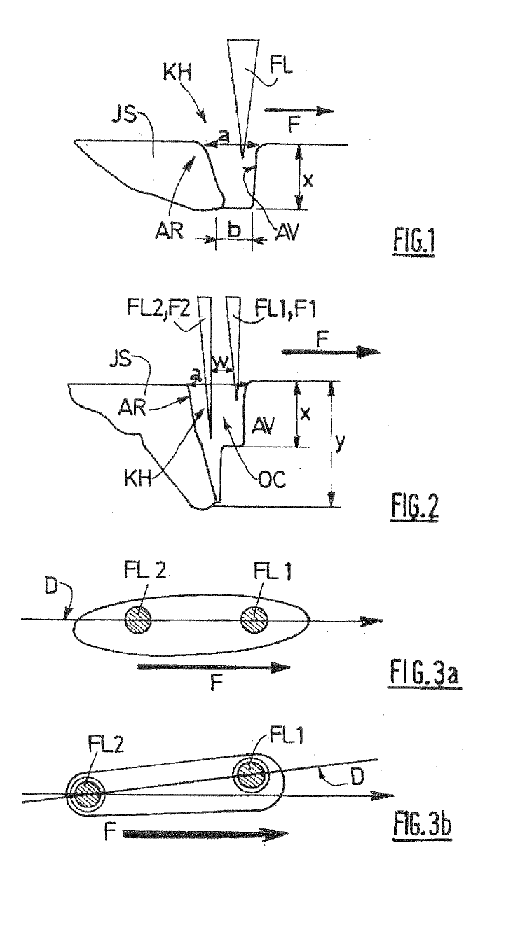

FIG. 1 shows schematically a laser welding process of the prior art; and

FIGS. 2, 3a and 3b illustrate the present invention.

More precisely, FIG. 1 shows schematically a laser welding process according to the prior art in which a single laser beam FL is used, which impacts and melts the material to be welded, forming a keyhole KH therein.

As mentioned above, in keyhole laser welding, a cavity or opening is created in the molten metal, the metal being progressively melted by the beam in the front part AV of this cavity KH. The laser beam is moved relative to the workpiece or workpieces to be welded (in the direction of the arrow F). The molten metal is pushed to the rear part AR of the keyhole KH, where it solidifies to form the welded joint JS.

With such a process, the opening of the keyhole KH is approximately equal to the cross section of the laser beam FL at the upper surface of the workpiece in question. Moreover, the depth x of penetration of the beam is limited and the width b of the keyhole bottom is generally equal to or smaller than the width a of the opening of the keyhole.

Consequently, when laser welding under these conditions, the penetration is always limited to the distance x.

FIG. 2 shows a laser welding process according to the invention.

More precisely, in this case, the process employs, on the one hand, a first laser beam FL1 which is focused onto the workpiece to be welded, so as to create therein a vapour capillary or keyhole KH with a central opening OC and, on the other hand, a second laser beam FL2 which is focused in the central opening OC of the keyhole KH created by the first laser beam FL1.

The progressive welding (the direction of advance being indicated by the arrow F) of the workpiece or workpieces to be welded therefore takes place by the metal melting at the points of impact of the two laser beams FL1, FL2 on the workpiece or workpieces to be welded.

According to the invention, the depth of penetration x of the first laser beam FL1 and the depth of penetration y of the second laser beam FL2 are such that: y>x, i.e. the second laser beam FL2 penetrates more deeply into the material to be welded than the first laser beam FL1.

In other words, a focal length f2 is chosen for the second laser beam FL2 and a focal length f1 is chosen for the first laser beam FL1 which are such that f2>f1, and preferably such that f2=f1+x.

Moreover the distance w between the respective axes of the two beams FL1 and FL2 is typically between a and b, i.e. a≧w≧b.

According to the invention, the first laser beam FL1 creates the keyhole and penetrates the material to a distance x, whereas the second beam FL2, focused in the central cavity OC of keyhole KH, melts the material over a greater distance, i.e. with a greater depth y.

To implement the invention, a laser device having a power of between 1 and 20 kW may be used.

Furthermore, to make it easier to implement the invention, a first gas may be delivered towards the opening of the keyhole so as to exert thereon a preferably continuous, uniform and constant gas pressure capable of enlarging the opening of the keyhole.

A second, shielding gas stream may advantageously also be distributed so as to cover the welding zone with a shielding gas, serving to prevent contamination of the weld pool by atmospheric impurities and/or, in the case of a CO₂ laser, to prevent a deleterious plasma forming.

The first gas has a composition identical to or different from the second gas.

Moreover, as illustrated in FIGS. 3a and 3b, which are enlarged top views of the welding zone according to the invention, the centres of the two beams FL1 and FL2 may be located on the same straight line D, which may be parallel to the welding direction indicated by the arrow F (FIG. 3a) or else it may make a non-zero angle, for example between 1° and 45°, to the welding direction (arrow F), i.e. in a “shifted” position (FIG. 3b). This is because a “shifted” configuration is beneficial in certain welding applications, especially for the welding of workpieces having different thicknesses that are positioned end to end, in butt welding or lap welding, for the welding of parts having the same thickness, which are positioned for lap welding, or else of the backside welding of several workpieces of the same thickness or different thicknesses.

In general, the invention allows workpieces with a thickness ranging from about 1 to 30 mm, preferably about 5 to 20 mm, to be welded effectively.

1. Welding process using a laser beam (FL1, FL2) to weld at least one metal workpiece, in which:
a) a first laser beam (FL1) is employed and said first laser beam (FL1) is focused so that it strikes at least one workpiece to be welded and creates a keyhole-type capillary (KH) having a keyhole opening;
b) a second laser beam (FL2) is used and said second laser beam (FL2) is focused in the keyhole (KH) opening created by said first laser beam (FL1); and
c) the workpiece or workpieces are progressively welded by melting the metal of the workpiece or workpieces to be welded at the points of impact of the laser beams (FL1, FL2) with the workpiece or workpieces to be welded,
characterized in that the depth of penetration (x) of the first laser beam (FL1) and the depth of penetration (y) of the second laser beam (FL2) are such that: y>x where x is the depth of the keyhole created by the first laser beam (FL1).

2. Process according to claim 1, characterized in that two metal workpieces are welded together.

3. Process according to claim 1, characterized in that the focal length (f2) of the second laser beam (FL2) and the focal length (f1) of the first laser beam (FL1) are such that f2>f1, preferably such that: f2=f1+x where x is the keyhole depth obtained with the first laser beam (FL1).

4. Process according to claim 1, characterized in that the laser beams (FL1, FL2) are obtained from a main beam, which is divided into said two beams (FL1, FL2) or from two separate laser beams of the same wavelength or of different wavelengths.

5. Process according to claim 1, characterized in that a first gas stream is used to create a dynamic, preferably continuous and constant, gas pressure on the opening of the vapour capillary created by the first laser beam (FL1) in order to keep it open and in that a second, shielding gas stream is furthermore employed, this being distributed peripherally with respect to the first gas stream.

6. Process according to claim 1, characterized in that the flow rate of the first gas is around 5 to 30 l/min, preferably around 10 to 20 l/min, and the flow rate of the second gas is around 15 to 40 l/min, preferably around 20 to 30 l/min.

7. Process according to claim 1, characterized in that the nozzle delivering the first gas stream is directed towards the keyhole.

8. Process according to claim 1, characterized in that the first and second gases are chosen from argon, helium, nitrogen and mixtures thereof, and possibly in smaller proportion CO₂, oxygen or hydrogen.

9. Process according to claim 1, characterized in that the laser beam is generated by a laser generator of the Nd:YAG, diode, ytterbium-doped fibre or CO₂ laser type.

10. Process according to claim 1, characterized in that the metal workpiece or workpieces to be welded are made of carbon steel, whether coated or not, aluminium or stainless steel.

11. Process according to claim 1, characterized in that the distance w separating the first laser beam (FL1) from the second laser beam (FL2) is such that: a<w<b where a is the width of the keyhole opening and b is the width of the keyhole bottom.

12. Process according to claim 1, characterized in that the straight line (D) passes through the centres of the first laser beam (FL1) and the second laser beam (FL2) is parallel to the welding direction (arrow F) or makes an angle of between 1 and 60° to said welding direction (arrow F).

13. Process according to claim 1, characterized in that an electric arc is generated at the keyhole so as to enlarge and stabilize the keyhole and the weld pool.

14. Process according to claim 1, characterized in that the nozzle delivering the first gas has a gas flow area smaller than the nozzle delivering the second gas.

15. Process according to either of claim 2, characterized in that the focal length (f2) of the second laser beam (FL2) and the focal length (f1) of the first laser beam (FL1) are such that f2>f1, preferably such that: f2=f1+x where x is the keyhole depth obtained with the first laser beam (FL1).
